(19) United States
(12) Patent Application Publication
(10) Pub. No.: US 2022/0261884 A1
(43) Pub. Date: Aug. 18, 2022

(54) SYSTEMS AND METHODS FOR PROVIDING A TIME EFFICIENT SIMULTANEOUS HIGH-VOLUME VEHICLE AUCTION SYSTEM

(71) Applicant: Phillip Steven Polen, Naples, FL (US)

(72) Inventor: Phillip Steven Polen, Naples, FL (US)

(21) Appl. No.: 17/178,068

(22) Filed: Feb. 17, 2021

(51) Int. Cl. G06Q 30/08; G06Q 30/06; G06Q 10/08

(52) U.S. Cl. CPC G06Q 30/08; G06Q 10/087; G06Q 30/0643

(57) ABSTRACT

A system for providing an online auction platform is disclosed, including at least one buyer device and at least one seller device in operable connection with a network. An application server is in operable communication with the network to host an application system for providing a simultaneous high-volume bidding auction system. The application system includes a user interface module for providing access to the application system to the buyer device and the seller device. The user interface is in operable communication with: a user database and an inventory database. An auction consignment interface displays units submitted by the seller device. Each unit can be bid on by a buyer simultaneously to permit the buyer to select one or more of the one or more units to transmit to a buyer watchlist interface. The buyers bidding interface permits the buyer to bid on the units simultaneously.

### TECHNICAL FIELD

The embodiments generally relate to computerized systems for providing an automotive auction and more specifically relate to computerized systems and methods which provide a time efficient simultaneous high-volume bidding digital auction platform.

### BACKGROUND

Automotive auctions are a method of selling vehicles based on an auction system. Most states only allow closed auctions which are only available to auto dealers. However, some states allow public auctions which can be accessed by the general public. Auctions are often an outlet for financial services firms to dispose of their large volume of off-lease returns, for rental car companies to sell their aging inventory, and for car dealerships to dispose of unwanted trade-ins or other inventory. Similarly, banks, the IRS, and the like may use automotive auctions to sell repossessed vehicles Automotive auctions, as well as auctions selling other assets, allow the buyers to bid on a single unit at a time with each unit being bid on in succession one by one. More often than not, buyers need to purchase multiple units, and must wait until each units turn to be auctioned making the bidding process time consuming and tedious. In such, the buyer must manage each unit individually that they wish to purchase taking much more time.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for providing an online auction platform, including at least one buyer device and at least one seller device in operable connection with a network. An application server is in operable communication with the Internet to host a digital application platform to provide a time efficient simultaneous high-volume bidding digital auction system. The application system includes a user interface module for providing access to the application system to the buyer device and the seller device. The user interface is in operable communication with a user database and an inventory database. An auction consignment interface displays units submitted by the seller's device. All units selected can be bid on by a buyer simultaneously. The time efficient simultaneous high-volume bidding digital auction system permits buyers to select various units they wish to bid on from the auction consignment section and send the selected units to their auction watchlist until the 15-minute (or other duration of time) time efficient simultaneous high-volume bidding digital auction starts. Buyers monitor their live auction section through the bidding interface and bid themselves and monitor all other bidders who are bidding against them.

Sellers can monitor a live auction bidding interface to readily monitor the status of each unit they are selling. The system and methods disclosed herein allow the user to quickly and easily purchase one or more units via the online time efficient Simultaneous high-volume bidding digital auction platform. The system provides an efficient means for engaging with an online auction platform and greatly reduces both the buyers and sellers time needed to buy or sell multiple units.

In one aspect, the inventory database stores a multitude of units and unit information.

In one aspect, the unit information is associated with a unit made available for auction.

In one aspect, the unit is a vehicle.

In one aspect, the unit information includes all of the following: the vehicle make, a vehicle model, a vehicle year, a vehicle color, a vehicle condition report, numerous photos, and a vehicle opening bid.

In one aspect, the system includes a seller bidding interface to permit the seller to monitor, manage units they are selling and also able to bid on units they have selected form the auction consignment together and simultaneously from the same screen.

In one aspect, the time efficient simultaneous high-volume bidding digital auction platform having an auction duration of 15-minutes more or less for 100's of cars simultaneously. The start time, and duration may be modified by the administrative user while still having a time efficient simultaneous high-volume bidding digital auction.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a screenshot of the auction consignment interface wherein a listing of units is displayed which the buyer may review and send selected units to their watchlist/live auction to bid on when the Time Efficient Simultaneous High-Volume bidding digital auction starts according to some embodiments;

FIG. 4A illustrates a screenshot of the unit details interface, according to some embodiments;

FIG. 4B illustrates a screenshot of the unit details interface, according to some embodiments;

FIG. 4C illustrates a screenshot of the unit details interface, according to some embodiments;

FIG. 5 illustrates a screenshot of the buyers watchlist interface wherein the buyer may monitor and manage units they are planning to bid on when the Time Efficient Simultaneous High-Volume bidding digital auction starts, according to some embodiments;

FIG. 6 illustrates a screenshot of the buyers live bidding interface, according to some embodiments;

FIG. 7 illustrates a screenshot of the sellers live bidding interface wherein the sellers can monitor their inventory of units placed up for auction, according to some embodiments;

FIG. 8 illustrates a screenshot of the sellers work sheet wherein the seller can accept the offers at the completion of the time efficient simultaneous high-volume bidding digital auction or enter a counter offer to the high bidder;

FIG. 9 illustrates a block diagram of the server engine and modules, according to some embodiments; and

FIG. 10 illustrates a flowchart of the method for a simultaneous high-volume auction system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an online auction system wherein users can simultaneously bid on a high-volume of multiple units in a short period of time. The time efficient simultaneous high-volume bidding digital auction system (hereinafter “system” or “the system”) permits buyers to select any number of various units they wish to bid on. Buyers can bid/monitor their live auction section within the 15-minute bidding process allowing the buyer to readily monitor all competing bids that are being placed. Sellers can monitor a live bidding interface to readily monitor the status of each unit they are selling. The system and methods disclosed herein allow the user to quickly and easily purchase multiple units via the Time efficient simultaneous high-volume bidding digital auction platform.

One skilled in the arts will readily understand that the embodiments provided herein may be applied to various industries which sell products (i.e., units) via an online auction platform. The examples provided herein relate to the automotive industry, wherein a “unit” is a vehicle. In such, the embodiments allow a buyer to bid and purchase a multiple of vehicles simultaneously within a short period of time.

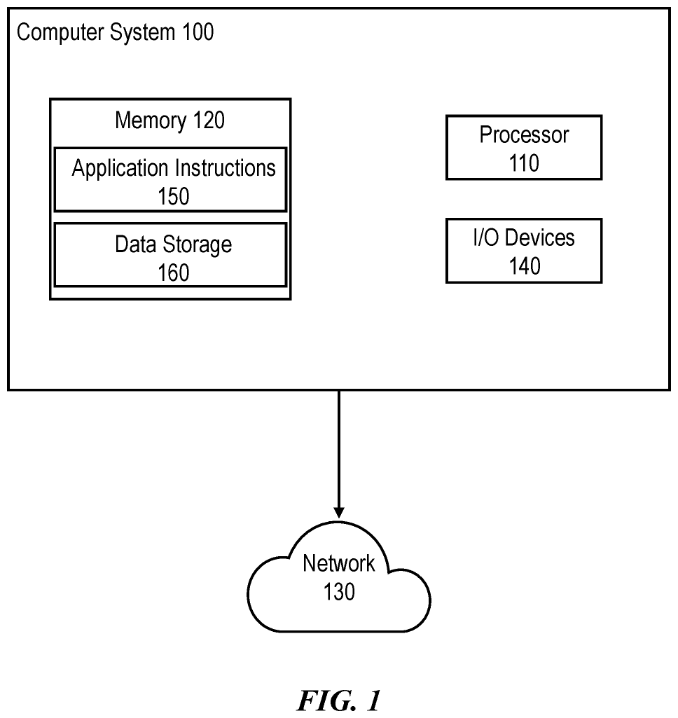

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, AWS Cloud systems and other Cloud providers or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

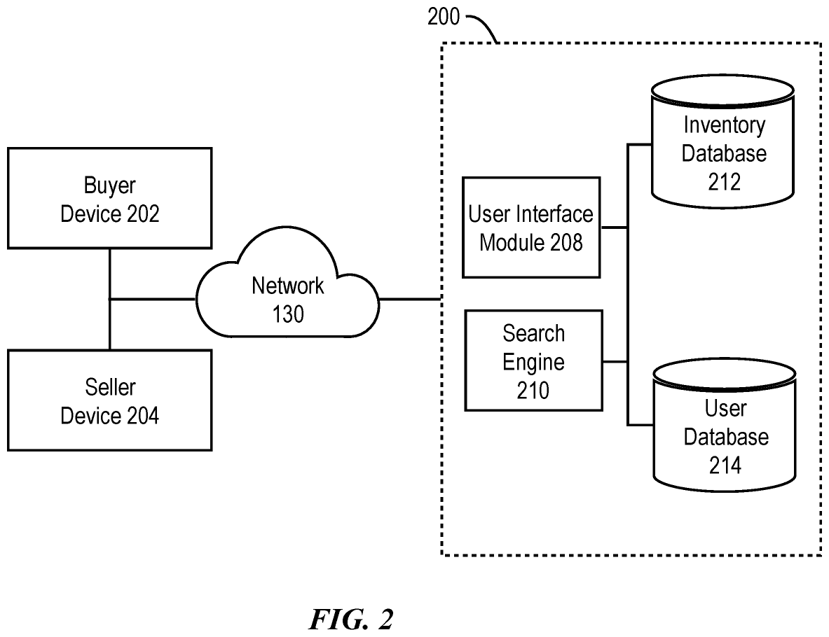

FIG. 2 illustrates a block diagram of the application system 200 in communication with a buyer device 202 and a seller device 204 via the network 130. One skilled in the arts will readily understand that buyers and sellers may be utilizing the system at a single time to interact in one or more auctions. The buyer device 202 is utilized by the buyer to view unit details (e.g., information related to a vehicle put up for auction such as the make, model, year, color, etc. of a vehicle), place bids, manage bids, execute a purchase, and various other processes associated with the online auction process. The seller device 204 may be utilized by the seller to submit unit information (e.g., the make, model, year, color, etc. of a vehicle). to be submitted to the online auction platform, and manage their inventory of units for sale before, during, and after the auction. The search engine 210 permits the buyer and seller to search an inventory database 212 and/or user database 214. The user interface module 208 displays information contained in the inventory database 212 and user database 214 to permit the user to interact with the system. It is an object of the embodiments to provide an efficient means for buying and selling vehicles (i.e., units) via a time efficient simultaneous high-volume bidding digital auction platform. In one example of the embodiments, the auction may have a start time of 4:00 PM EST and an end time of 4:15 PM EST. In such, the auction starts and ends in a short time period (e.g., 15-minutes) selling hundreds of vehicles. This is made possible by permitting the buyers to bid on a multitude of units simultaneously, rather than individually (one at a time) or engaging in unit auctions throughout the day as is known as ask/bid auctions in the arts. One skilled in the arts will readily understand that the start time, end time, and duration is not limited to the example provided above and may vary (e.g., having different start and end times as well as having a shorter or longer duration of the auction).

The inventory database 212 may store information related to multiple units (e.g., vehicles) which have been submitted for sale by the seller. The user database 214 may store user information including user preferences, user permissions, user history as a buyer and/or a seller, etc.

In some embodiments, the unit information, wherein the unit is a vehicle, may include information such as, but not limited to the vehicle make, model, year, color, condition, vehicle history, location of the vehicle, mileage, opening bid, multiple photos etc.

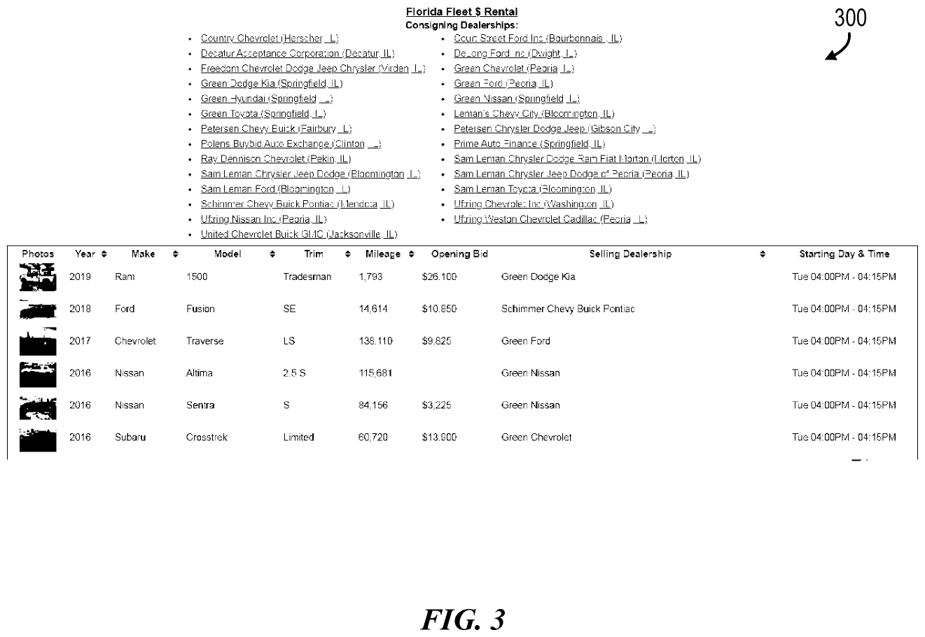

FIG. 3 illustrates a screenshot of the auction consignment interface 300 wherein a listing of units is displayed which the buyer may bid on. The auction consignment interface 300 displays multiple vehicles (i.e., units) and their associated information such as images of the vehicle, year, make, model, trim, mileage, opening bid price, dealership, and ending date, starting and ending time of the auction. Vehicle information is input by the seller prior to the start of the auction.

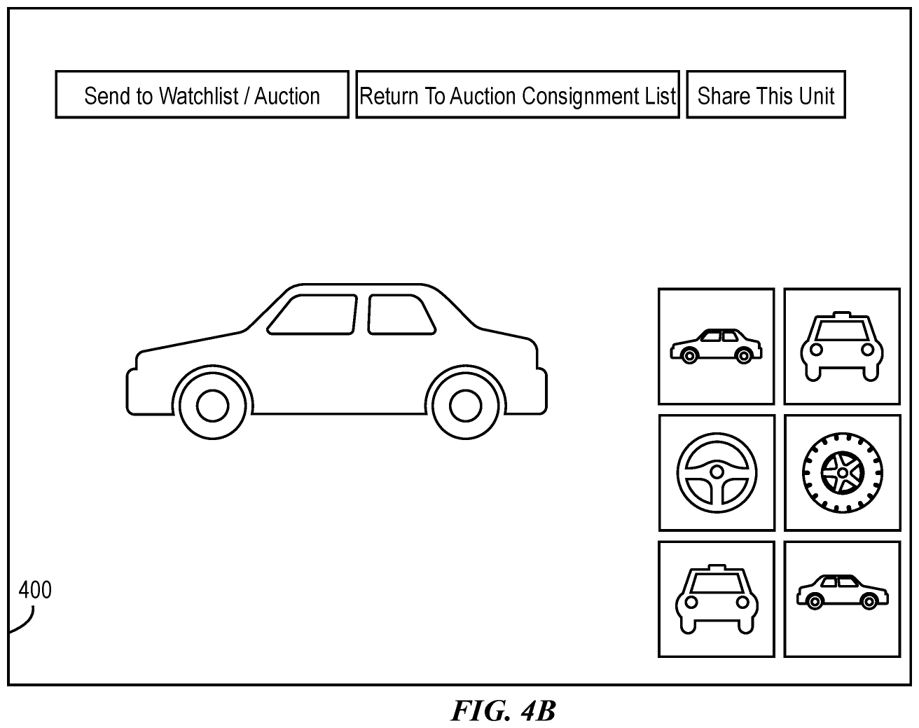

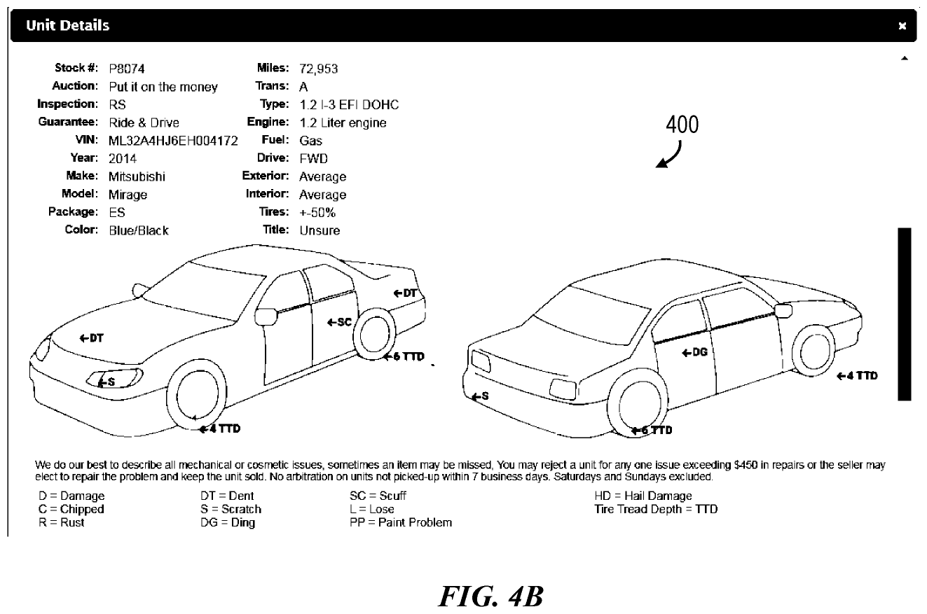

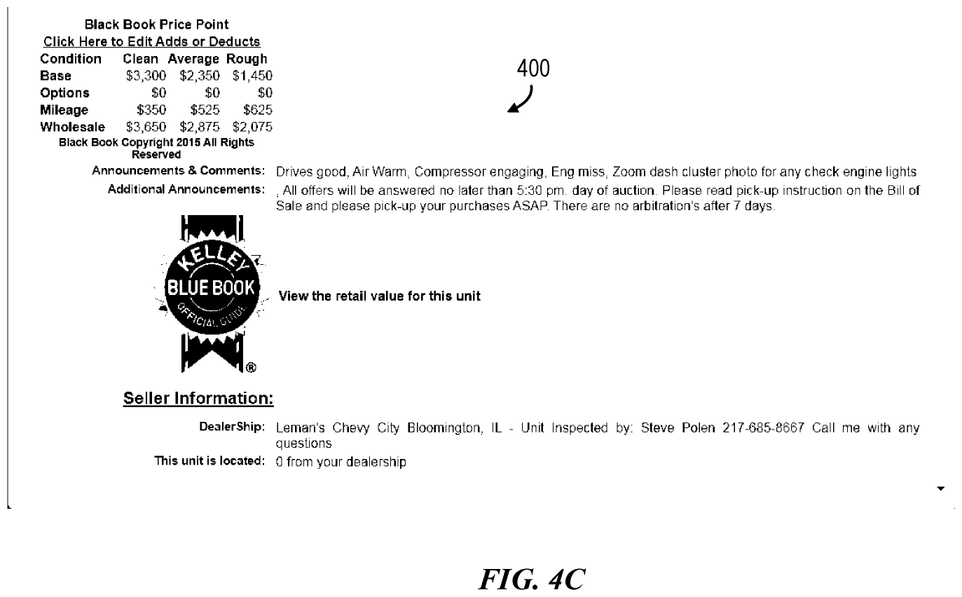

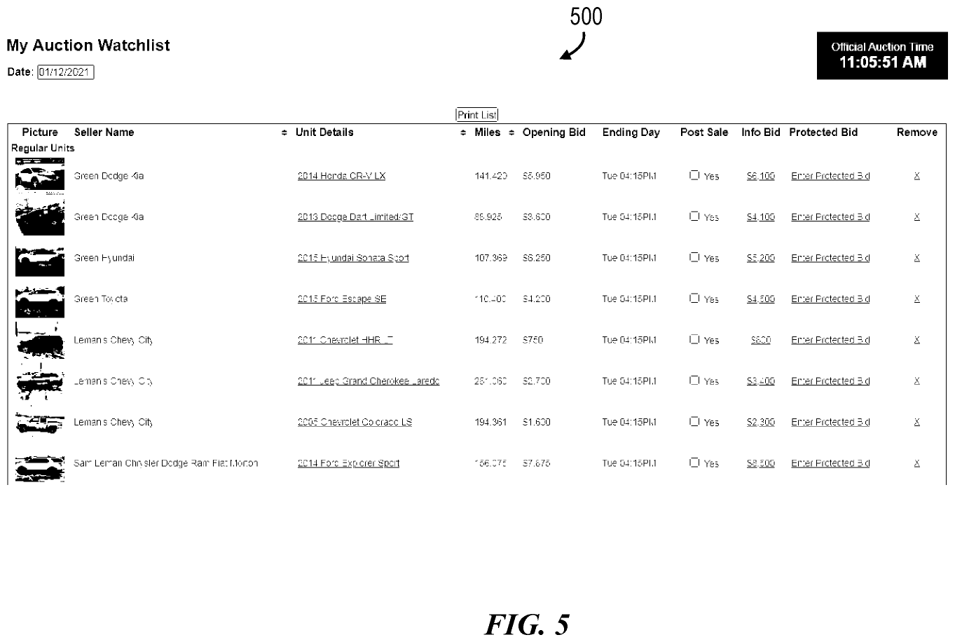

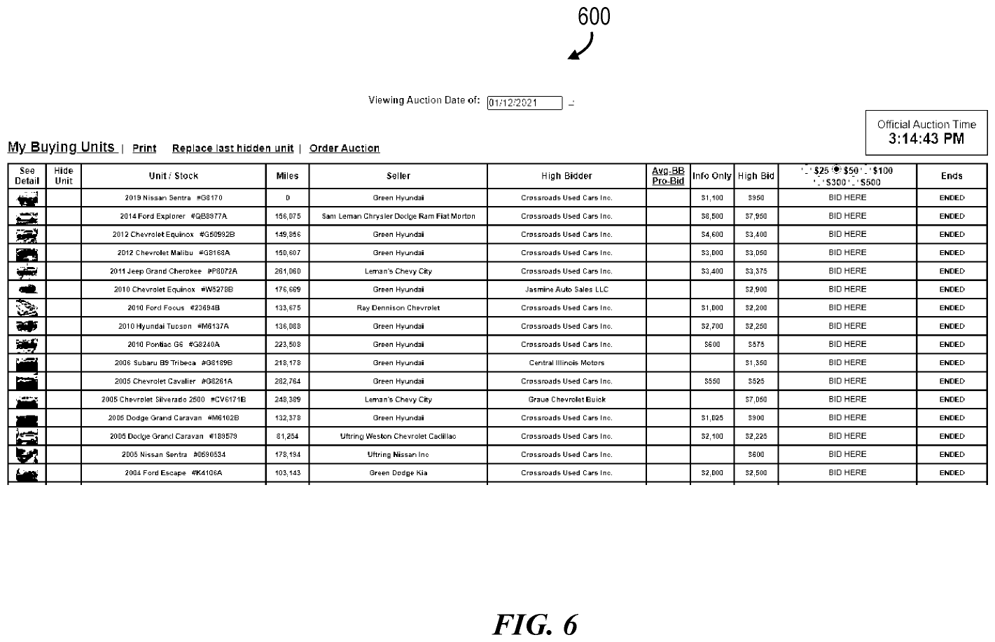

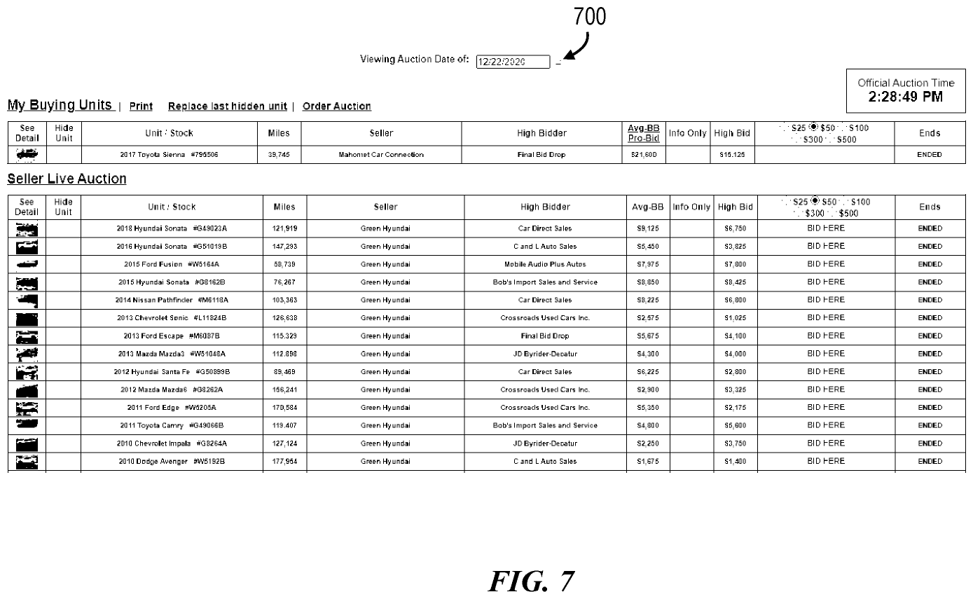

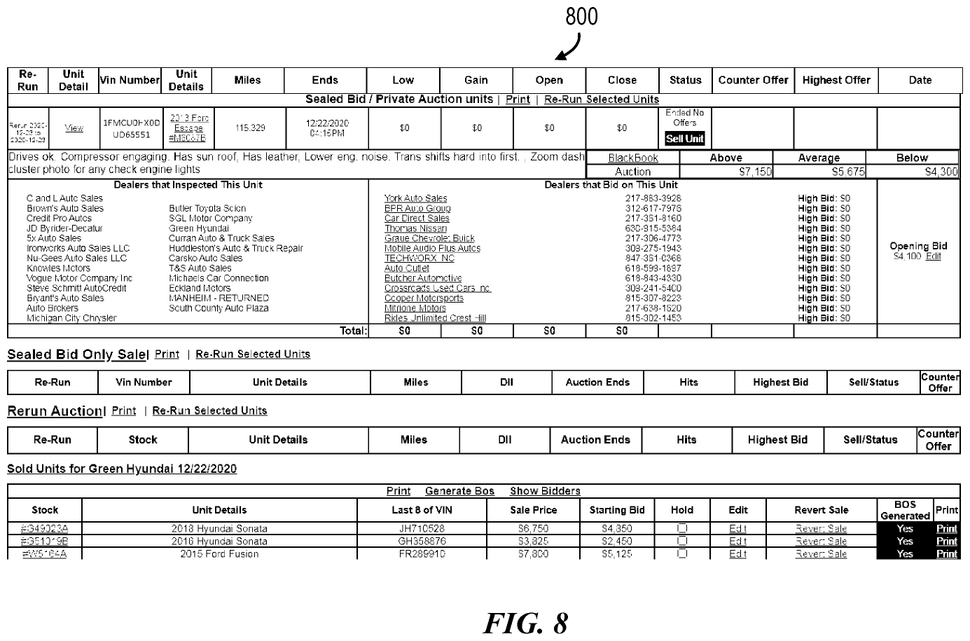

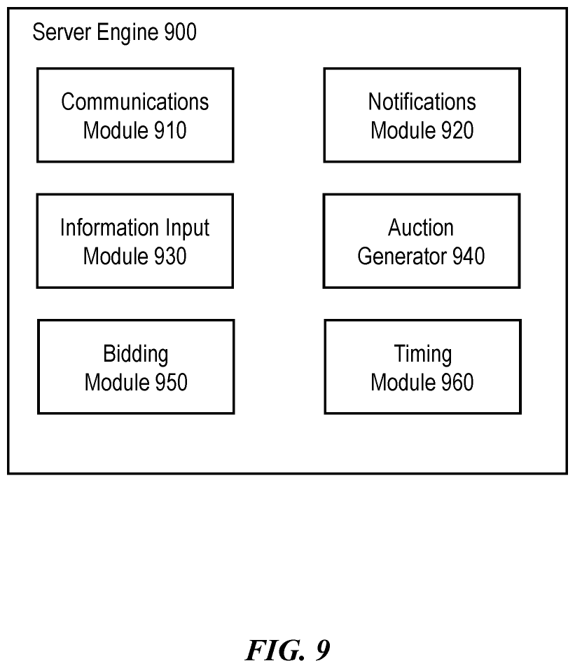

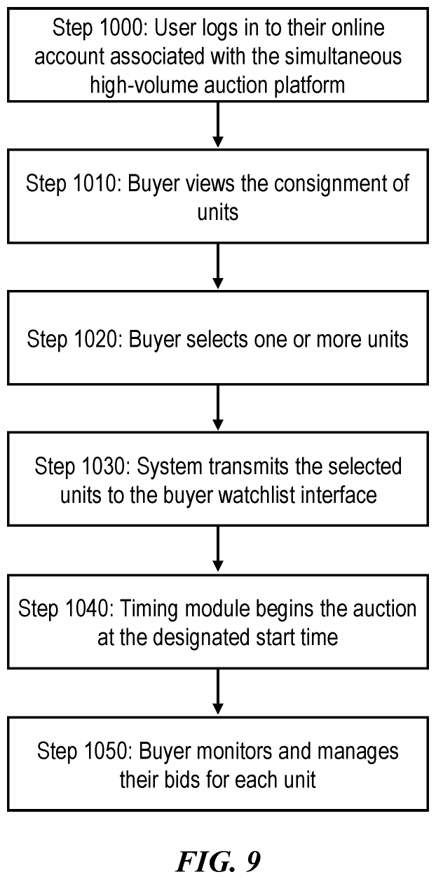

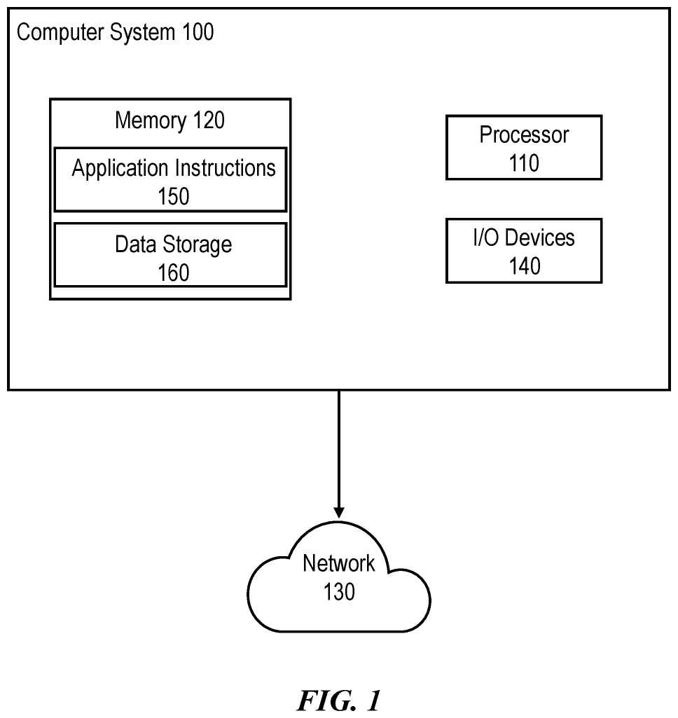

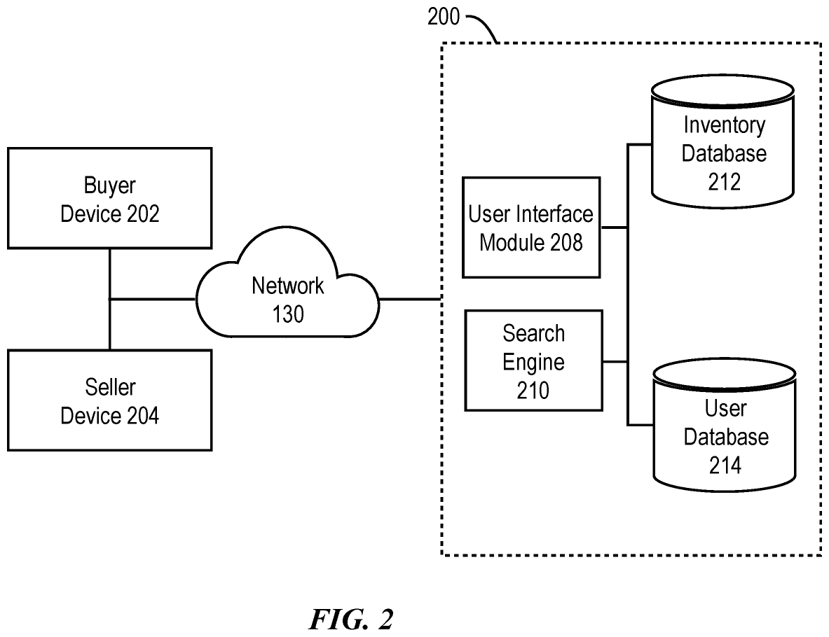

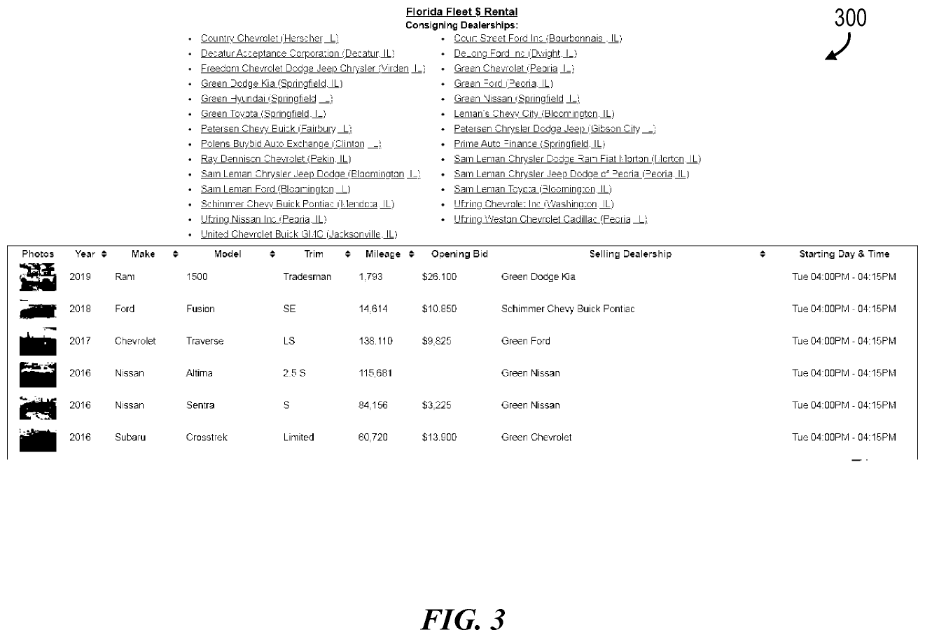

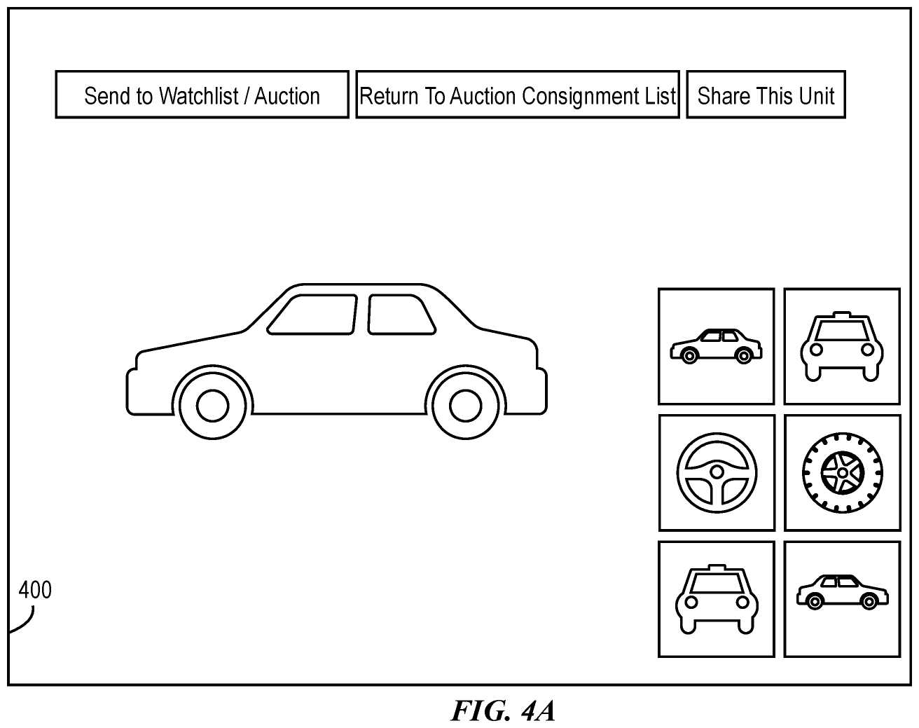

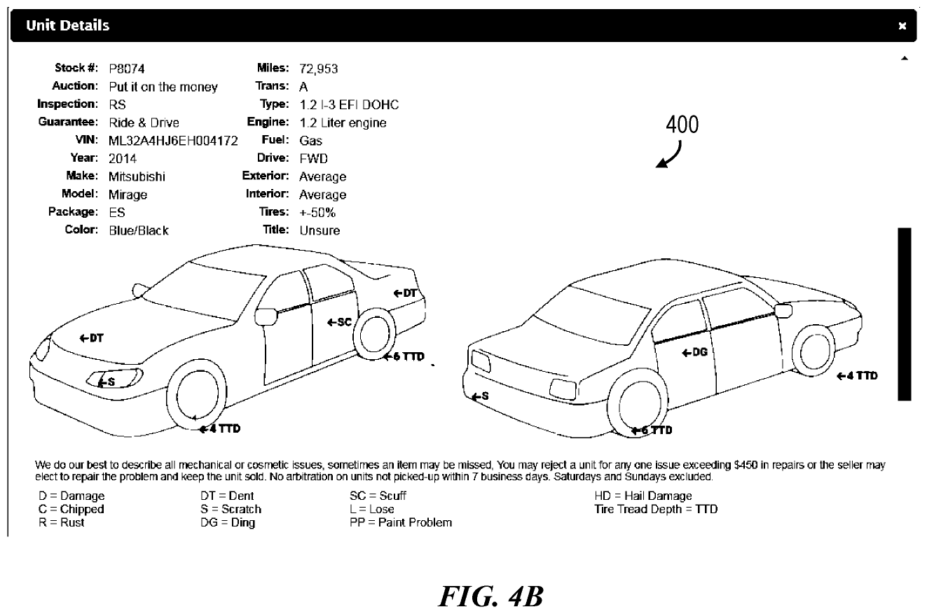

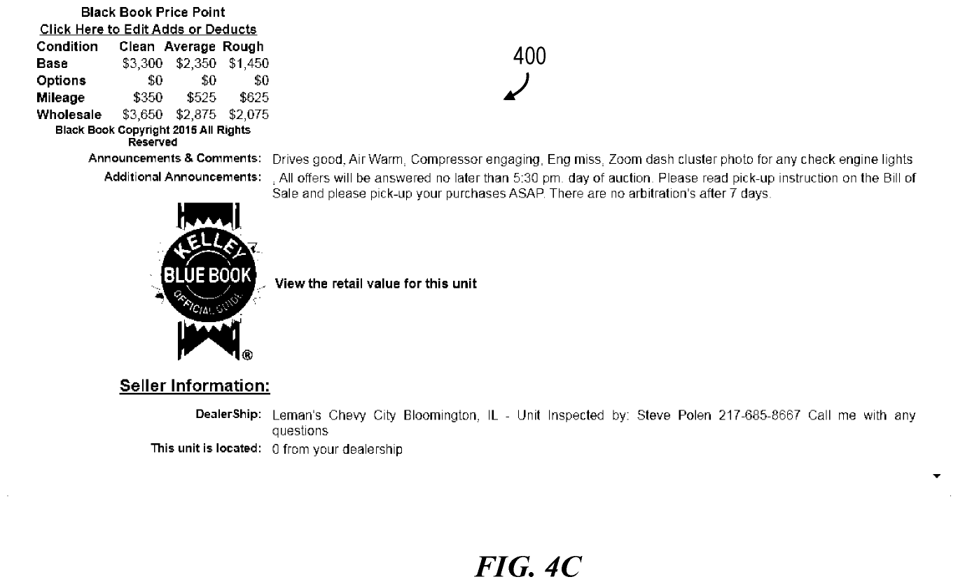

FIG. 4A-4C illustrates a screenshot of the unit details interface 400 wherein the seller has input various details for the buyers related to the condition of the unit they are selling. In one example, the unit details interface includes multiple images of the vehicle as well as indicate on the image 710 any areas of concern or problems with the vehicle. Indicators may be coded and referenced using a key (i.e., a legend or glossary) to define each code. For example: C=Chipped, D=Damage, CR=Cracked, Dent=Dt, DG=Ding, Sc=Scuff, HD=Hail Damage, S=Scratch, L=Lose, PP=Paint problem, R=Rust, TTD=Tire Tread Depth. Further, the seller can input comments or additional details related to the vehicle. In some embodiments, the unit details interface 400 permits the seller to input images of the interior, exterior, custom components, damage, and general condition of the vehicle. The seller may also include a link to a vehicle history report, vehicle evaluation report, etc. using third-party systems. In such, the system allows the seller to indicate any known or potential issues such that the buyer can make an informed bid and potential purchase of the vehicle.

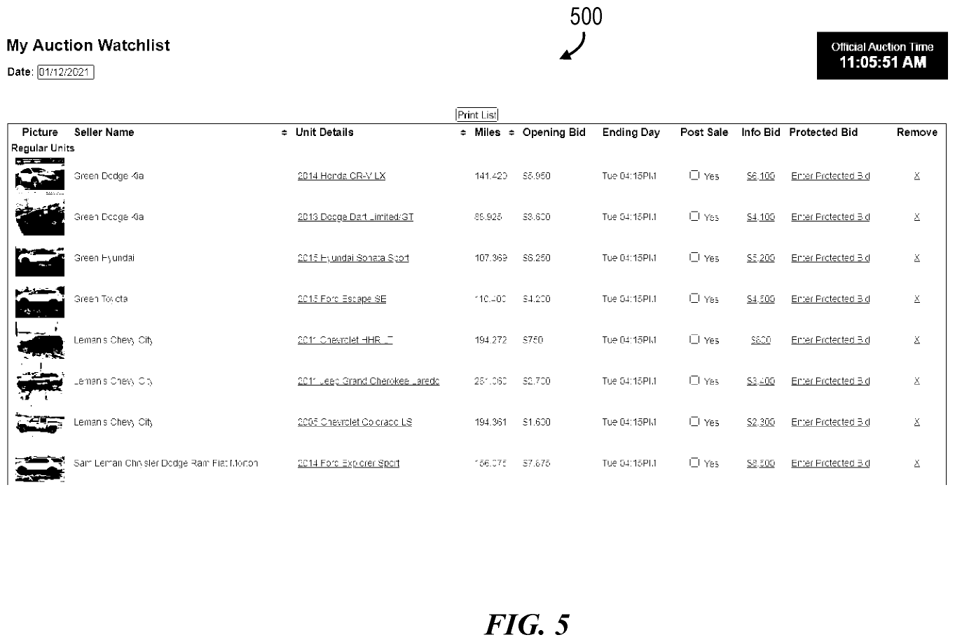

FIG. 5 illustrates a screenshot of the buyers watchlist interface 500 wherein the buyer sends multiple units that he selected from the auction consignment section for further review before the Time Efficient Simultaneous High-Volume bidding digital auction starts. The buyers watchlist interface 500 includes unit details, opening bid, end date, and start time, etc. Further, the buyer may select to enter a protected bid which allows the computer to bid in the absence of the live buyer. The buyers watchlist interface 500 is intended to provide a focused and distilled view of units which the buyer wants to bid on/purchase, or is otherwise interested in.

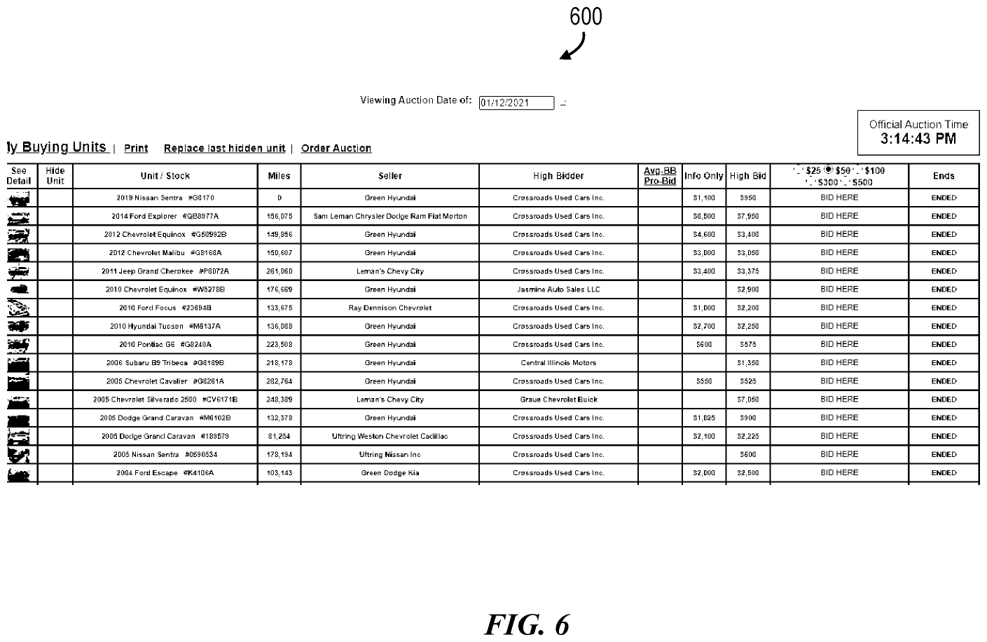

FIG. 6 illustrates a screenshot of the buyers live bidding interface 600 which is utilized by the buyer to place bids simultaneously on multiple units he has selected from the auction consignment section. The buyers bidding interface 600 provides various functionalities. Buyers may review details one final time and other information related to each unit (e.g., view images of the vehicle, year, make, model, trim, mileage, opening bid price, selling dealership, etc.), hide the unit (i.e., remove the unit from the buyers bidding interface), see the unit name and stock number, view mileage, the high bidder and bid amount, the average Black Book value, when the bidding ends, and the option to place a bid using a bid tab. There is a bid tab where the bidder can set the bid amounts (e.g., $25, $50, $100, $300, $500, etc.).

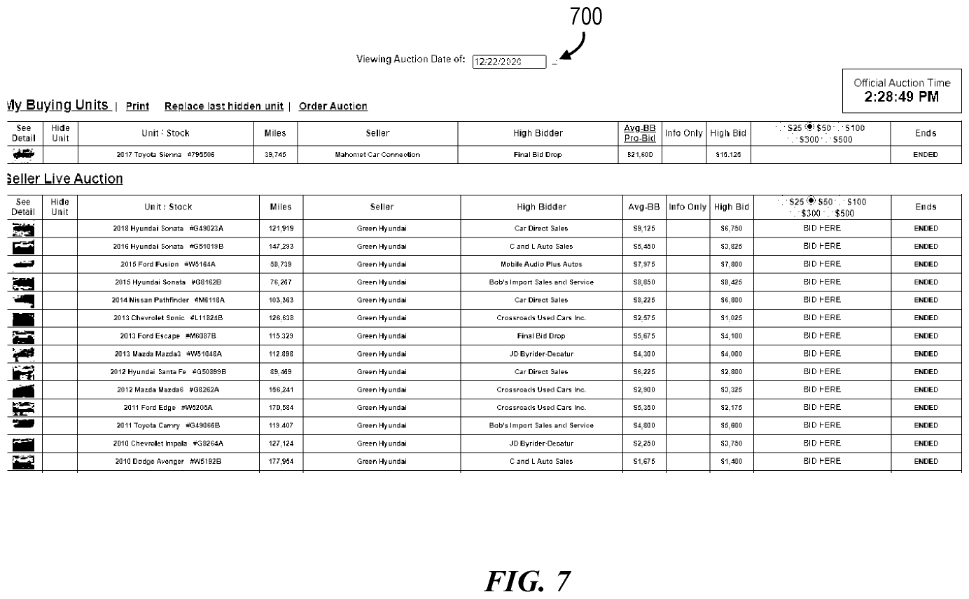

FIG. 7 illustrates a screenshot of the sellers live bidding interface 700 wherein the sellers can monitor and manage their inventory of units placed up for auction. The sellers bidding interface 700 displays a real-time view of each unit they have placed up for auction. In such, the sellers bidding interface is updated in real-time during the auction as well as after the auction. A status indicator may be provided to indicate the status of the auction (e.g., ongoing, in overtime, ended). Using the sellers bidding interface 700, the seller can view details and information related to each unit (e.g., view images of the vehicle, year, make, model, trim, mileage, opening bid price, current bid price, buying dealership, and remaining time of the auction,

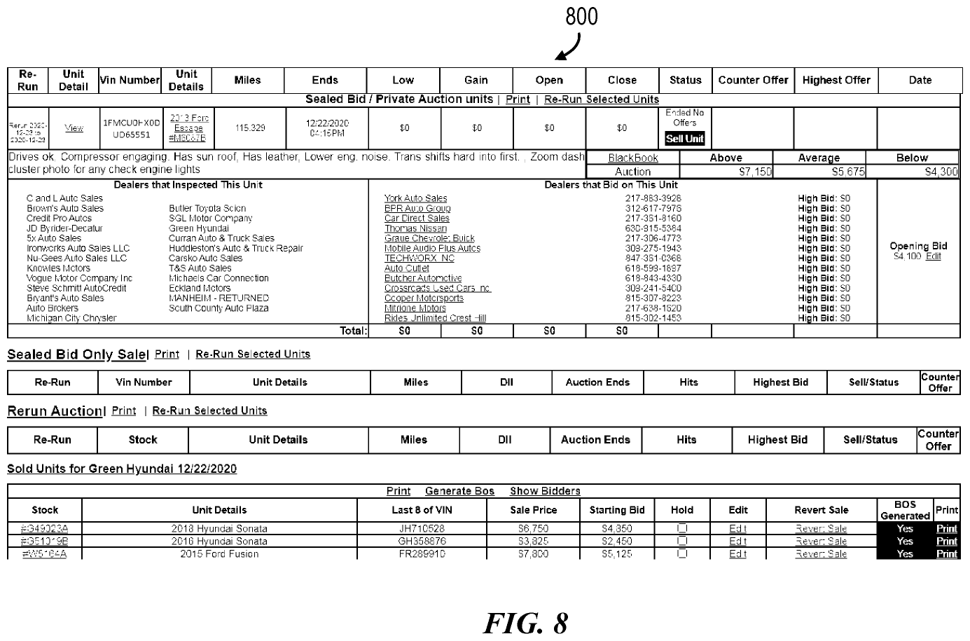

FIG. 8 illustrates a screenshot of the sellers work sheet 800 where the seller can view all buyers that reviewed the units, how many buyers sent that unit to their watchlist, review Black Book wholesale values, and accept the offers at the completion of the time efficient simultaneous high-volume bidding digital auction or enter a counter offer to the high bidder.

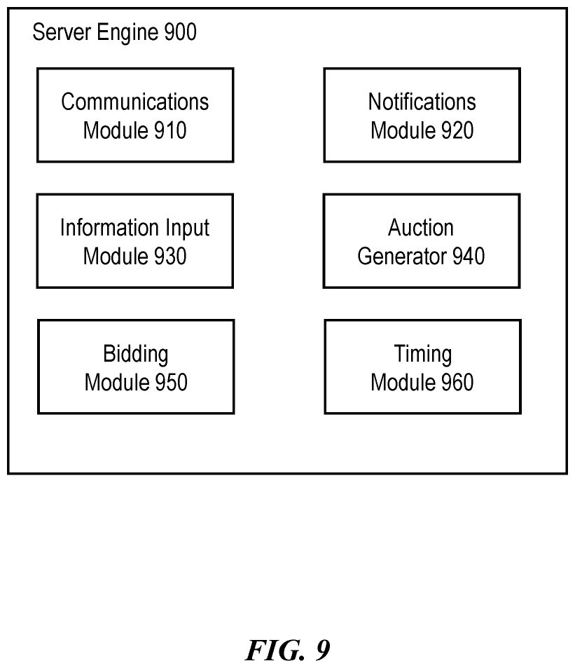

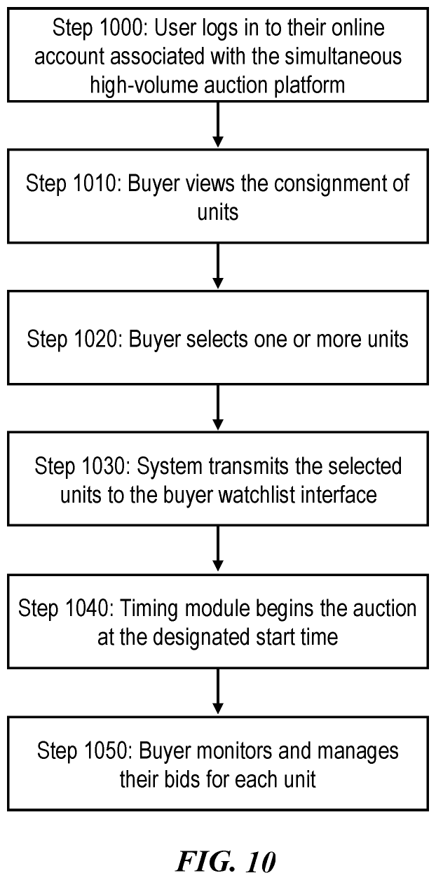

FIG. 9 illustrates a block diagram of the server engine 900 and modules including a communications module 910, notifications module 920, information input module 930, auction generator 940, bidding module 950, and timing module 960. The communication module 910 permits the communication of information related to buyer information, seller information, unit details and information, as well as communications between the buyers and sellers before, during, or after the auction. The notifications module 920 generates notifications to the buyer and or the seller. The notifications may include status of an auction, alerts related to the start and end of an auction, status of a bid placed by the buyers, etc. The information input module 930 allows the seller to input unit information and associate the information with a specific unit made available for auction. The auction generator 940 permits an administrative user of the system to organize an auction and establish auction parameters (e.g., type of auction and industry of the auction, start time, end time, etc.). The bidding module 950 permits bids to be selected for each unit and submitted to the auction system. The timing module 960 may activate the auction and bidding functionalities for a pre-determined period of time. Further, the timing module may permit an overtime bidding period that continues past the pre-determined time period until someone surrenders.

FIG. 9 illustrates a flowchart of the process for the time efficient simultaneous high-volume bidding digital auction system. In step 1000 the user logs in to their online account associated with the simultaneous high-volume auction platform. In step 1010, the buyer views the consignment of units that are listed on the auction consignment interface for a specific auction. In step 1020, the buyer selects one or more units to submit a bid. Optionally, the buyer may view unit details. In step 1030, the system transmits the selected units to the buyer watchlist interface. In step 1040, the timing module starts the auction to permit live bidding by the buyers. In 1050 buyer monitors and manages their bids until the end of the auction, or until the buyer loses interest in a unit. This may include removing units from their live auction, placing additional bids, and the like.

Many different embodiments have been disclosed herein, in connection with the above description and the drawings. It will be understood that it would be unduly repetitious and obfuscating to describe and illustrate every combination and sub-combination of these embodiments. Accordingly, all embodiments can be combined in any way or combination, and the present specification, including the drawings, shall be construed to constitute a complete written description of all combinations and sub-combinations of the embodiments described herein, and of the manner and process of making and using them, and shall support claims to any such combination or sub-combination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a sub-combination or variation of a sub-combination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing an auction platform, the system comprising:
at least one buyer device and at least one seller device in operable connection with a network;
an application server in operable communication with the network, the application server configured to host an application system for providing a simultaneous high-volume auction system, the application system having a user interface module for providing access to the application system to the at least one buyer device and the at least one seller device, the user interface in operable communication with: a user database and an inventory database, the user interface comprising:
an auction consignment interface to display a one or more units submitted by multiple sellers devices, wherein each of the one or more units can be bid on by a buyer simultaneously, and to permit the buyer to select one or more of the one or more units to transmit to a buyer watchlist interface, the buyer watchlist interface to the buyers bidding interface to permit the buyer to simultaneously bid on a multitude of units.

2. The system of claim 1, wherein the inventory database stores unit information.

3. The system of claim 2, wherein the unit information is associated with a unit made available for auction.

4. The system of claim 3, wherein the unit is a vehicle.

5. The system of claim 4, wherein the unit information includes at least one of the following: a vehicle make, a vehicle model, a vehicle year, a vehicle color, a vehicle condition, and a vehicle starting bid.

6. The system of claim 1, further comprising a seller bidding interface.

7. The system of claim 6, wherein the seller bidding interface permits the seller to monitor each unit.

8. The system of claim 1, wherein the simultaneous high-volume auction system provides an online auction platform having an auction duration of 15-minutes.

9. The system of claim 8, wherein an administrative user selects the auction duration.

10. The system of claim 9, wherein the administrative user selects an auction start time and end time.

11. A system for providing an auction platform, the system comprising:
at least one buyer device and at least one seller device in operable connection with a network;
an application server in operable communication with the network, the application server configured to host an application system for providing a simultaneous high-volume bidding auction system, the application system having a user interface module for providing access to the application system to the at least one buyer device and the at least one seller device, the user interface in operable communication with: a user database and an inventory database, the inventory database associated with an auction consignment interface, the user interface comprising:
the auction consignment interface to display one or more units submitted by the seller device, wherein each of the one or more units can be bid on by a buyer simultaneously, and to permit the buyer to select one or more of one or more units to transmit to a buyer watchlist interface, the buyer watchlist interface to the buyers bidding interface to permit the buyer to bid simultaneously on the one or more units; and
a unit details interface to permit the seller to input one or more areas of concern on the vehicle, wherein the areas of concern are provided as an indicator on an image of the unit, wherein the indicator is associated with a key.

12. The system of claim 11, further comprising a buyers bidding interface to permit the buyer to input a bid for each unit simultaneously.

13. The system of claim 12, wherein the buyer can input a bid amount for each unit simultaneously.

14. The system of claim 11, wherein the inventory database stores unit information.

15. The system of claim 14, wherein the unit information is associated with a unit made available for auction.

16. The system of claim 15, wherein the unit is a vehicle.

17. The system of claim 16, wherein the unit information includes at least one of the following: a vehicle make, a vehicle model, a vehicle year, a vehicle color, a vehicle condition, and a vehicle starting bid.

18. The system of claim 17, further comprising a seller bidding interface.

19. The system of claim 18, wherein the seller bidding interface permits the seller to monitor each unit.

20. A method for a simultaneous high-volume auction platform, the method comprising the steps of:
logging in to an application system via the buyer;
viewing a consignment of units;
selecting one or more units provided on the consignment of units;
transmitting, via the system, the one or more selected units to a buyer watchlist interface; and
bidding, via the buyers bidding interface, on the one or more selected units simultaneously.
